(19) United States
(12) Patent Application Publication
(10) Pub. No.: US 2025/0129916 A1
(43) Pub. Date: Apr. 24, 2025

(54) A TRUNK FIXTURE FOR A TRUNKING ILLUMINATION SYSTEM FOR LINE ILLUMINATION, AS WELL AS A TRUNKING ILLUMINATION SYSTEM COMPOSED OF ONE OR MORE OF SUCH TRUNK FIXTURES

(71) Applicant: SIGNIFY HOLDING B.V., EINDHOVEN (NL)

(72) Inventor: KRZYSZTOF CEZARY ZAREMBA, BIALYSTOK (PL)

(21) Appl. No.: 18/684,992

(22) PCT Filed: Aug. 16, 2022
(86) PCT No.: PCT/EP2022/072850

§ 371 Date: Feb. 20, 2024

(30) Foreign Application Priority Data
Aug. 20, 2021 (EP) 21192373.5

(51) Int. Cl. F21V 17/00; F21S 2/00; F21S 4/28; F21S 8/06; F21V 3/06; F21V 15/01; F21V 17/08; F21V 21/02; F21V 23/00

(52) U.S. Cl. CPC F21V 17/002; F21S 2/005; F21S 4/28; F21S 8/061; F21V 3/0625; F21V 15/01; F21V 17/08; F21V 21/025; F21V 23/001

(57) ABSTRACT

Proposed is an elongated trunk fixture for a trunking illumination system for line illumination, the elongated trunk fixture at least comprising a fixture housing comprising a light exit opening and a light exit window connected to the fixture housing and covering the light exit opening, the fixture housing being composed of an elongated strip shaped fixture base plate and elongated fixture wall plates, the elongated fixture wall plates being releasably connected with the elongated strip shaped fixture base plate.

### TECHNICAL FIELD

The disclosure relates to an illumination system for line illumination composed of multiple elongated trunk fixtures longitudinally connected in line with each other, thereby forming a self-sustained trunked illumination system. More in particular the disclosure relates to a novel configuration of such trunk fixture.

### BACKGROUND OF THE DISCLOSURE

An illumination system for line illumination as outlined above is commonly known and finds general application in illuminating large room areas, in particular or office spaces, retail spaces (supermarkets), manufacturing areas, warehouses, distribution centers, etc. etc. Such illumination system for line illumination is composed of multiple elongated trunk fixtures, which are suspended from a ceiling and are longitudinally connected in line with each other. Accordingly, a self-sustained trunked illumination system is formed, suitable to cover and illuminate large spaces are indicated above.

The individual elongated trunk fixture of such known illumination system are composed of a fixture housing and a fixture cover mounted thereon, the former being provided with one or more light emitting sources as well as the necessary power supply electronics and the latter being provided with at least an optical light emitting window. The fixture housing and the fixture cover are connected with each other, often by means of a click-snap connection.

This mounting approach requires high manufacturing tolerances of both the fixture housing as well as the fixture cover. Moreover additional suspension cables between both parts are required for safety reasons, for example when replacement or adjustment operations are to be performed.

Thus, when the entire trunking line composed of multiple interconnected trunk fixtures is mounted to a ceiling, it is difficult to disassembly the illumination system without causing damage to the fixture housing and/or the fixture cover as the click-snap connection existing between both parts should be enough high from safety reasons.

It is thus desirable to present an illumination system for line illumination composed of multiple elongated trunk fixtures, as well as such trunk fixture, which is easy and safe to assembly and disassembly without risk of damage.

### SUMMARY OF THE DISCLOSURE

The disclosure proposes an elongated trunk fixture, which is suited to be part of a trunking illumination system for line illumination. Accordingly, the elongated trunk fixture at least comprising a fixture housing comprising a light exit opening and a light exit window connected to the fixture housing and covering the light exit opening, the fixture housing being composed of an elongated strip shaped fixture base plate and elongated fixture wall plates, the base plate being provided with at least one light emitting element, the elongated fixture wall plates being releasably connected with the elongated strip shaped fixture base plate, wherein both the elongated strip shaped fixture wall plates and the light exit window are made from a flexible synthetic material.

Herewith a novel, modular design of a trunk fixture is obtained, which is easy and safe to assembly and disassembly without risk of damage.

In an example, the elongated fixture wall plate is provided with a first edge near a first longitudinal side of the elongated fixture wall plate, and with the first edge interacting with the longitudinal edge of the elongated strip shaped fixture base plate.

In a preferred example of the disclosure, the first edge of the elongated fixture wall plate or the longitudinal edge of the elongated strip shaped fixture base plate are provided with an elongated thickened part, which elongated thickened part releasably fits in an elongated slot provided on the longitudinal edge of the elongated strip shaped fixture base plate or the first edge of the elongated fixture wall plate.

The connection thus achieved between both parts is considered reliable, yet flexible, and thus can be easily and safely be assembled as well as disassembled.

The novel, modular design of the trunk fixture is further improved, as in an further example of the disclosure the elongated fixture wall plates are releasably connected with the light exit window.

Preferably, the elongated fixture wall plate is provided with a second edge near a second longitudinal side of the elongated fixture wall plate, the second edge releasably interacting with a longitudinal edge of the light exit window, and more in particular the second edge of the elongated fixture wall plate or the longitudinal edge of the light exit window are provided with an elongated thickened part, which elongated thickened part releasably fits in an elongated slot provided on the longitudinal edge of the light exit window or the second edge of the elongated fixture wall plate.

This further modular design further improves the assembly and disassembly of the several parts of the trunk fixture. The connection thus achieved between all parts is considered reliable, yet flexible, and thus can be easily and safely be assembled as well as disassembled.

Preferably, the light exit window is configured as an elongated strip shaped light exit plate, wherein the light exit plate is made from said flexible material, such as polycarbonate, and the wall plates are made from flexible, typically opaque, synthetic material. However, for a desired aesthetic glow effect the wall plates could be diffusely translucent for visible light, for example being light reflective for about 90% and light transmissive for about 10%.

In a further example of the trunk fixture, which establishes an improved light emission through the light exit window, the trunk fixture is provided with an elongated reflector plate. The elongated reflector plate is preferably manufactured from a light reflective material, such as from specular aluminium or from a sheet metal painted white.

In an example, which guarantees a proper mounting and connection between these parts, yet also allows for an easy assembly and disassembly thereof, the elongated fixture wall plate is provided with an upright elongated fixture wall plate flange interacting with a longitudinal edge of the elongated reflector plate.

The elongated strip shaped fixture base plate is provided with at least one light emitting element, and preferably as well as with power electronics for supplying power to the at least one light emitting element.

Additionally, the elongated strip shaped fixture base plate is provided with suspension openings for attachment with suspension power supply wiring.

The present disclosure also pertains to an illumination system for line illumination composed of two or more elongated trunk fixtures as disclosed in this disclosure.

It should be noted that the novel, modular design of the trunk fixture according to the disclosure can be manufactured and shipped as a kit of loose parts, with the kit at least comprising an elongated strip shaped fixture base plate, at least two elongated fixture wall plates; and an elongated light exit window plate according to the disclosure. Additionally, the kit of loose parts may further comprise an elongated reflector plate according to the disclosure.

### BRIEF DESCRIPTION OF THE DRAWINGS

The disclosure will now be discussed with reference to the drawings, which show in:

FIGS. 1A-1B and 2A-2B schematically illustrates an example of a component of an embodiment of an illumination system for line illumination according to the present disclosure;

FIGS. 3A-3C schematically illustrates an example of a further component of an embodiment of the illumination system for line illumination according to the present disclosure;

FIGS. 4A-4B schematically illustrates an example of another example of the illumination system for line illumination according to the present disclosure;

FIGS. 5A-5D schematically illustrates the mounting principle of the several components for assembling an embodiment of the illumination system for line illumination according to the present disclosure.

### DETAILED DESCRIPTION OF THE DRAWINGS

For a proper understanding of the disclosure, in the detailed description below corresponding elements or parts of the disclosure will be denoted with identical reference numerals in the drawings.

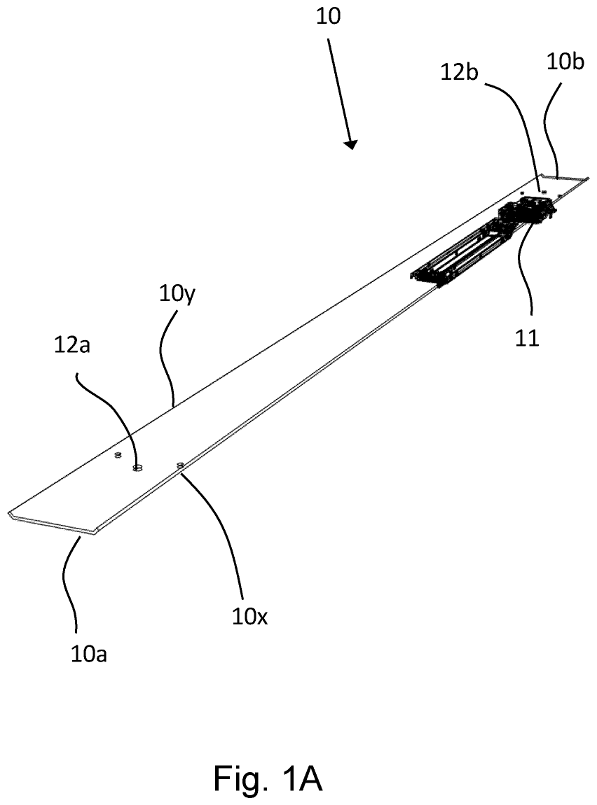

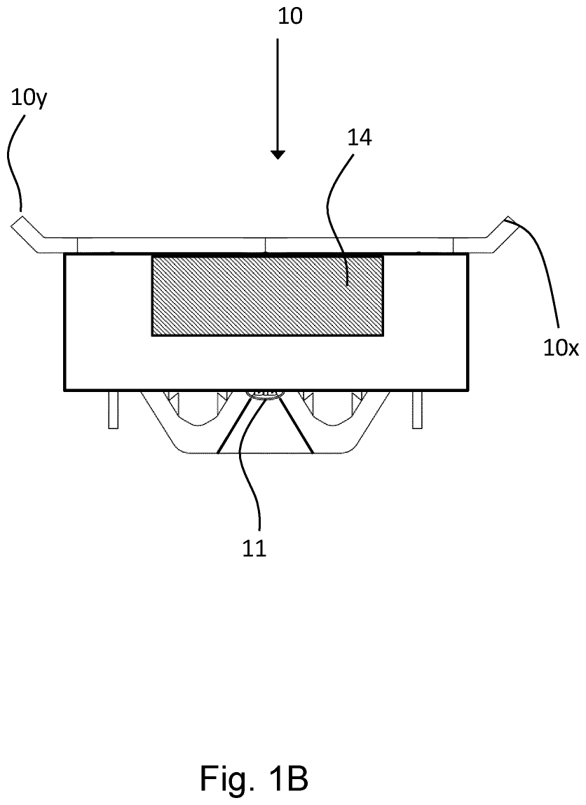

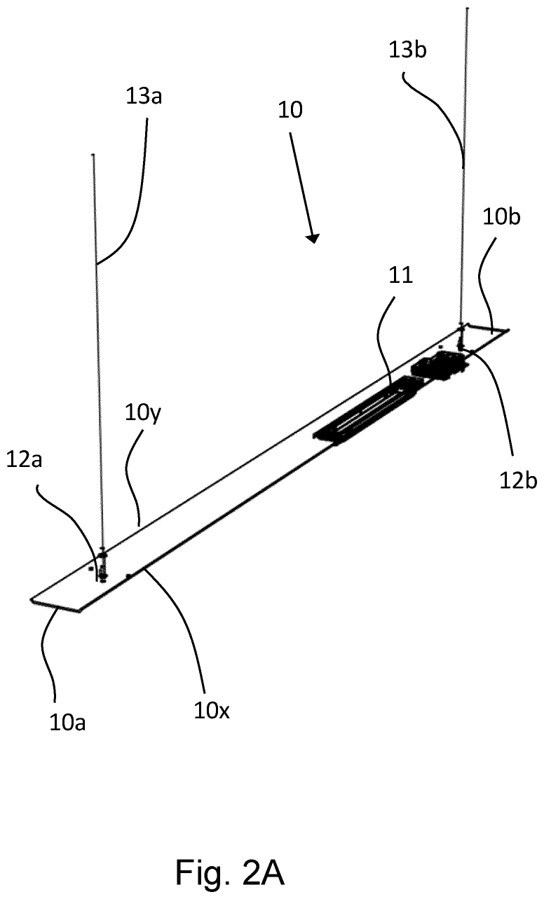

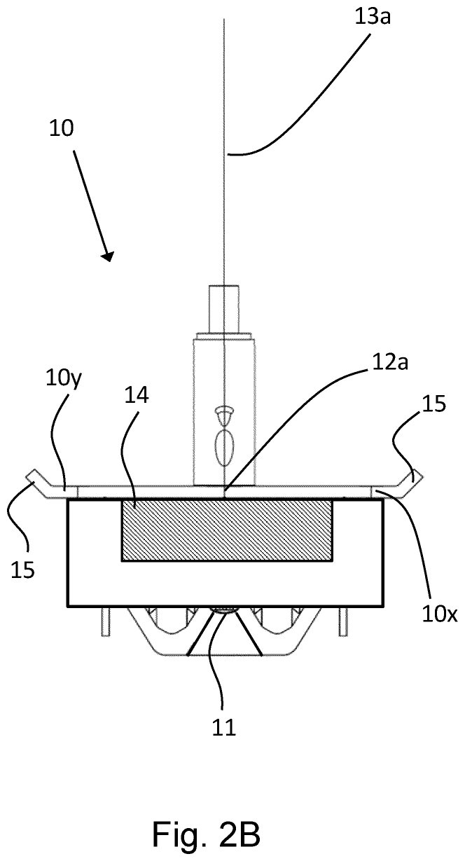

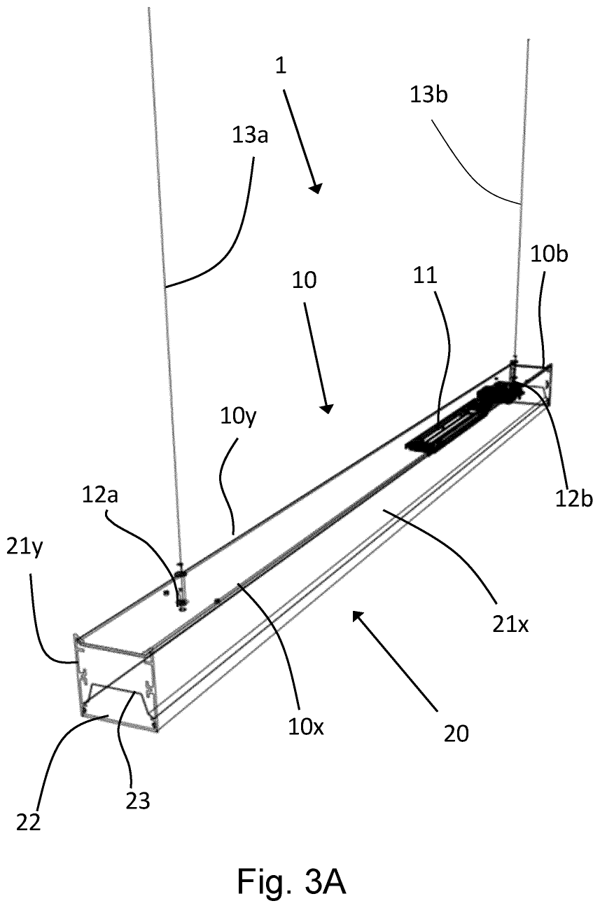

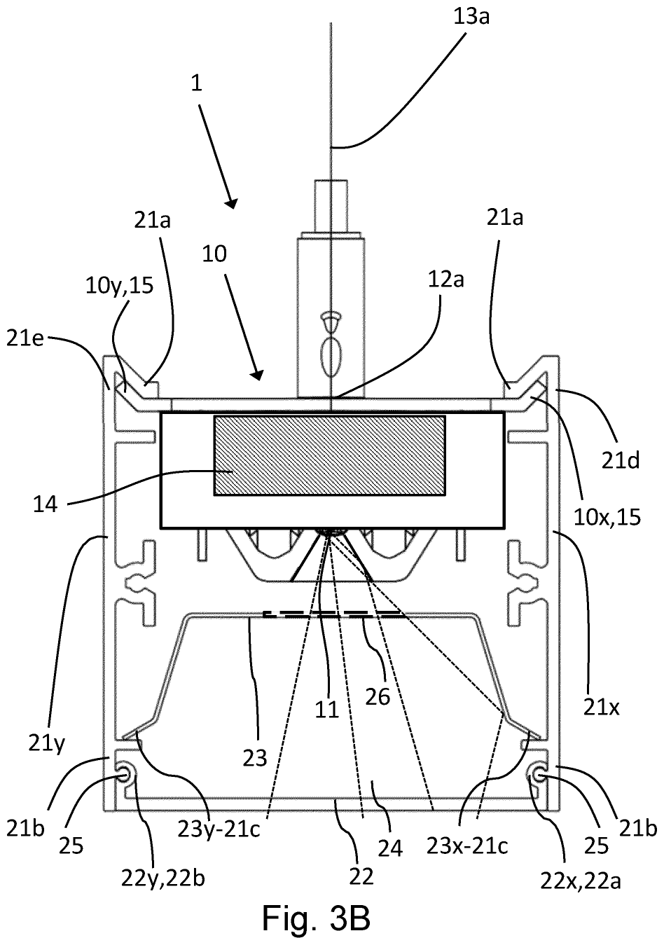

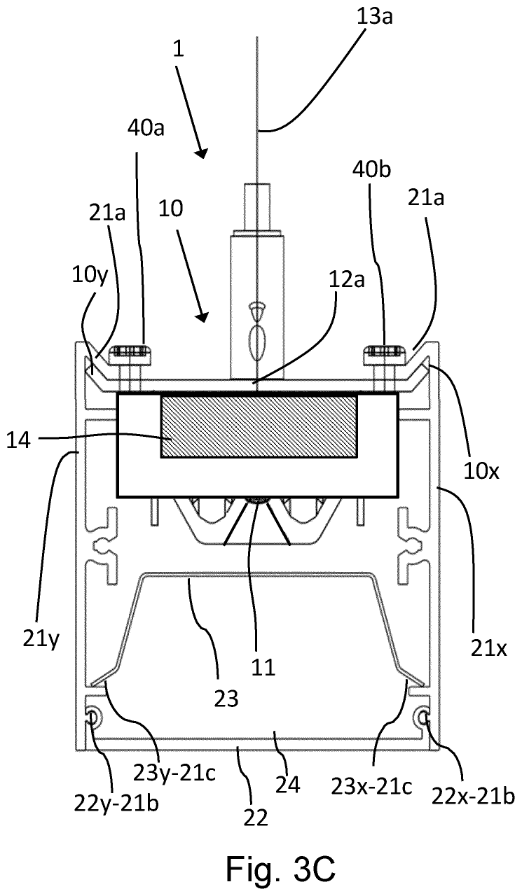

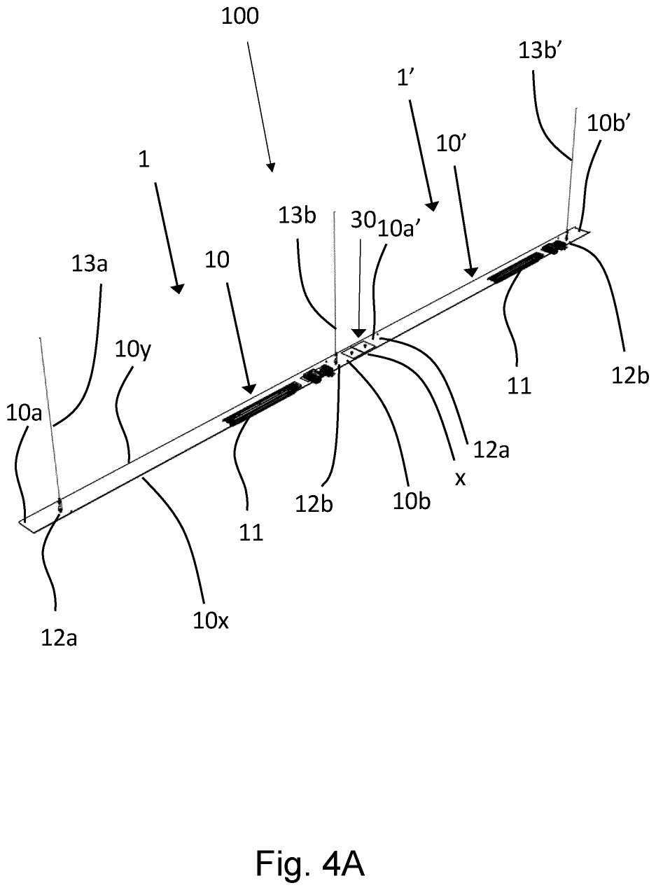

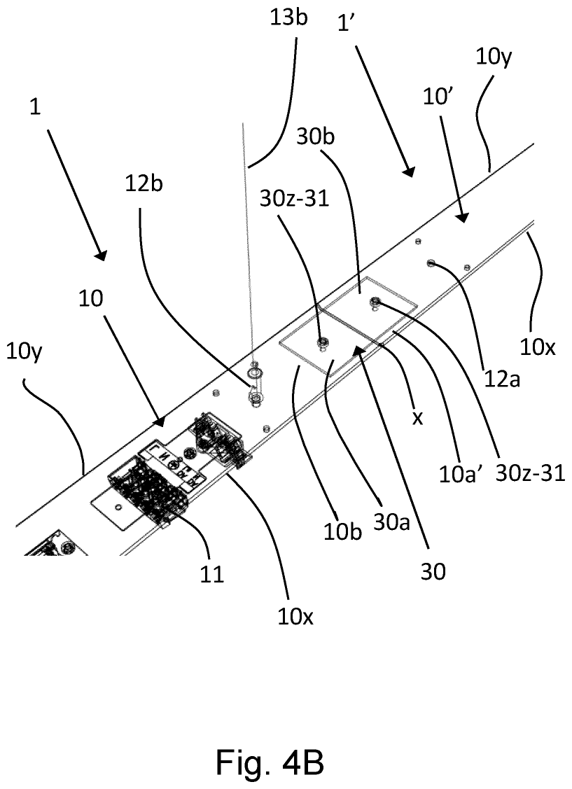

FIGS. 3A-3C depict schematically an example of a trunk fixture according to the disclosure. The trunk fixture according to the disclosure is of a novel, modular design with the several parts forming the modular design being depicted in FIGS. 1A-1B, and 2A-2B. FIGS. 4A-4B depict an example of an illumination system for line illumination being composed of one or more (here two) modular trunk fixtures according to the disclosure, interconnected with each other.

An illumination system for line illumination is commonly known and finds general application in illuminating large room areas, in particular or office spaces, retail spaces (supermarkets), manufacturing areas, warehouses, distribution centers, etc. etc. Such illumination system for line illumination is composed of multiple elongated trunk fixtures, which are suspended from a ceiling and are longitudinally connected in line with each other. Accordingly, a self-sustained trunked illumination system is formed, suitable to cover and illuminate large spaces are indicated above.

The individual elongated trunk fixture of such known illumination system are composed of a fixture housing and a fixture cover mounted thereon, the former being provided with one or more light emitting sources as well as the necessary power supply electronics and the latter being provided with at least an optical light emitting window. The fixture housing and the fixture cover are connected with each other, often by means of a click-snap connection.

This mounting approach requires high manufacturing tolerances of both the fixture housing as well as the fixture cover. Moreover additional suspension cables between both parts are required for safety reasons, for example when replacement or adjustment operations are to be performed. Thus, when the entire trunking line composed of multiple interconnected trunk fixtures is mounted to a ceiling, it is difficult to disassembly the illumination system without causing damage to the fixture housing and/or the fixture cover as the click-snap connection existing between both parts should be enough high from safety reasons.

In this disclosure a novel, modular design of an elongated trunk fixture is proposed, which is suited to be part of a trunking illumination system for line illumination.

Accordingly, with reference to the FIGS. 1A-1B, 2A-2B and 3A-3C, a single elongated trunk fixture is denoted with reference numeral 1 (1′) at least comprising a fixture housing 20 comprising a light exit opening 24 and a light exit window 22 connected to the fixture housing 20 and covering the light exit opening 24. The fixture housing 20 is composed of an elongated strip shaped fixture base plate 10 and elongated fixture wall plates 21x-21y.

The elongated strip shaped fixture base plate 10 has a flat, strip shape configuration and is provided with a left longitudinal base plate side edge 10x and a right longitudinal base plate side edge 10y. The fixture base plate 10 also has two base plate ends 10a and 10b. Preferably, the elongated strip shaped fixture base plate 10 is provided with at least one light emitting element 11 as well as with power electronics 14 for supplying power to the at least one light emitting element 11.

It should however be noted that multiple light emitting elements 11 (also referred to as light emitting sources) can be mounted to the elongated strip shaped fixture base plate 10 along its full length thereof, in order to establish an evenly distributed light 30 distribution.

Additionally, in order to allow for a proper suspension of each trunk fixture 1 from a ceiling, the elongated strip shaped fixture base plate 10 is provided with suspension openings 12a-12b, preferably two suspension openings 12a-12b, which are each worked in the material of the elongated strip shaped fixture base plate 10 near either base plate end 10a and 10b. The suspension openings 12a-12b serve for the attachment of proper suspension cable of wiring 13a-13b (13b′). Preferably, at least one of the suspension cables, here denoted with 13b and 13b′ are combined suspension/power supply cables also capable of providing power via the ceiling towards the power electronics 14/at least one light emitting source 11.

See FIGS. 2A-2B and 4A-4B for a detailed depiction of the suspension of a first trunk fixture 1 and a further trunk fixture 1′, which are interconnected with each other, thus forming an illumination system 100 for line illumination according to the disclosure using multiple suspension cables (combined suspension/power supply cables) 13a-13b-13b′.

The two elongated fixture wall plates 21x-21y have in a preferred example the same longitudinal length as that of the elongated strip shaped fixture base plate 10 and can releasably connected with the elongated strip shaped fixture base plate 10.

In order to establish a reliable, yet flexible connection between these parts, which connection can easily and safely be assembled as well as disassembled, each first and second longitudinal side edge 10x and 10y of the elongated fixture base plate 10 is provided with a bend base plate edge portion 15 also referred to as a base plate ridge, which interacts with a first longitudinal wall plate edge 21a of each elongated strip shaped fixture wall plate 21x and 21y.

As clearly depicted in for example FIG. 3B, each first and second longitudinal side 10x and 10y of the elongated fixture base plate 10 has an upward bend base plate ridge 15, which serves as an upward directed rest for the hook-shaped first longitudinal wall plate edge 21a near a first longitudinal side 21d of each elongated strip shaped fixture wall plate 21x and 21y. Accordingly, when placed along each upward bend base plate edge 15, the hook-shaped first longitudinal edge wall plate 21a of each elongated strip shaped fixture wall plate 21x and 21y ensures a flexible, yet reliable connection between both parts.

In another example (not depicted) of the disclosure, the longitudinal edge 10x-10y of the elongated fixture base plate 10 or the first longitudinal wall plate edge 21a of the elongated fixture wall plate 21x-21y can be provided with an elongated thickened part, which elongated thickened part releasably fits in an elongated slot provided on the longitudinal edge 10x-10y of the elongated fixture base plate 10 or the first longitudinal wall plate edge 21a of each elongated fixture wall plate 21x-21y.

This alternative connection ensures also a flexible, yet reliable connection between both parts 10 and 21x-21y. This modular design of a trunk fixture 1 (1′) is easy and safe to assembly and disassembly without any risk of damage to the fragile edges of the individual parts 10, 21x-21y.

The novel, modular design of the trunk fixture has further improvement, as the elongated fixture wall plates 21x-21y are also releasably connected with a light exit window 22.

The light exit window 22 has preferably the same longitudinal length as that of the elongated strip shaped fixture base plate 10, and both elongated fixture wall plates 21x-21y. Preferably, the light exit window 22 is configured as an elongated strip shaped light exit plate made from a flexible material, such as polycarbonate.

The elongated fixture wall plates 21x-21y are releasably interconnected with both the elongated strip shaped fixture base plate 10 and the elongated light exit window 22, such that the elongated light exit window 22 is located at a certain distance from the elongated strip shaped fixture base plate 10. Light emitted by the multiple light emitting sources mounted on the elongated strip shaped fixture base plate 10 exits the trunk fixture 1 (1′) via the elongated light exit window 22 as an even light line distribution.

In a further example of the trunk fixture 1 (1′) according to the disclosure, an improved light emission through the light exit window 22 is established with the additional provision of an elongated reflector plate 23 within the trunk fixture 1 (1′). The elongated reflector plate 23 is preferably manufactured from a light reflective material, such as specular aluminium or from a sheet metal painted white. The elongated reflector plate 23 has a reflector opening 26 in front of the light emitting source (only depicted in FIG. 3B) and a specific angled configuration, ensuring an optimal optic distribution of promoting light as emitted by the light emitting sources to exit through the light exit window 22.

For a proper mounting and connection between the elongated reflector plate 23 and both elongated fixture wall plates 21x-21y, each elongated fixture wall plate 21x-21y is provided with an upright elongated fixture wall plate flange 21c, which extends inwardly to the inner space formed by the assembled trunk fixture 1 (1′). Each upright elongated fixture wall plate flange 21c interacts with a longitudinal reflector plate edge 23x-23y of the elongated reflector plate 23. This further detail of the modular design of the trunk fixture 1 (1′) according to the disclosure allows for an easy assembly and disassembly.

The elongated fixture wall plates 21x-21y are provided with a second wall plate edge 21b near the other longitudinal side 21e of each elongated fixture wall plate. The second wall plate edge 21b interacts releasably with a first/second longitudinal edge 22x-22y of the light exit window 22. In this particular example, the second wall plate edge 21b of the elongated fixture wall plate 21x-21y is formed as an elongated wall plate thickened part 25, which extends over the full longitudinal dimension of the elongated fixture wall plate 21x-21y. The elongated wall plate thickened part 25 fits releasably in an elongated slot 22a-22b, which is provided on and extends over the full longitudinal dimension of both longitudinal edges 22x-22y of the light exit window 22.

In an alternative example (not depicted), the second wall plate edge 21b of the elongated fixture wall plate 21x-21y is formed as an elongated slot, which extends over the full longitudinal dimension of the elongated fixture wall plate 21x-21y. Similarly, both longitudinal edges of the light exit window 22 are formed as elongated thickened parts, which fits releasably in the elongated slots of each elongated fixture wall plate.

These two additional modular designs further improves the assembly and disassembly of the several parts 10 (10′), 21x-21y and 22 (and additionally 23) of the trunk fixture 1 (1′). The connections thus achieved between all parts are considered reliable, yet flexible, and thus can be easily and safely be assembled as well as disassembled.

Referring to FIG. 3A, in order to guarantee stability during use of the illumination system for line illumination, fixating screws 40a-40b are used for fixating the hook-shaped first longitudinal wall plate edge 21a of each elongated strip shaped fixture wall plate 21x and 21y with the elongated strip shaped fixture base plate 10. The fixating screws 40a-40b fit in suitable fixating openings (not depicted) present in the elongated strip shaped fixture base plate 10.

The modular assembly 20 of the elongated strip shaped fixture wall plates 21x and 21y with the light exit window 22 and optional the elongated reflector plate 23 is characterized by its flexible, reliable, yet releasable interconnections between the parts, in particular established by the click-snap connections of the ridges fitting in the slots.

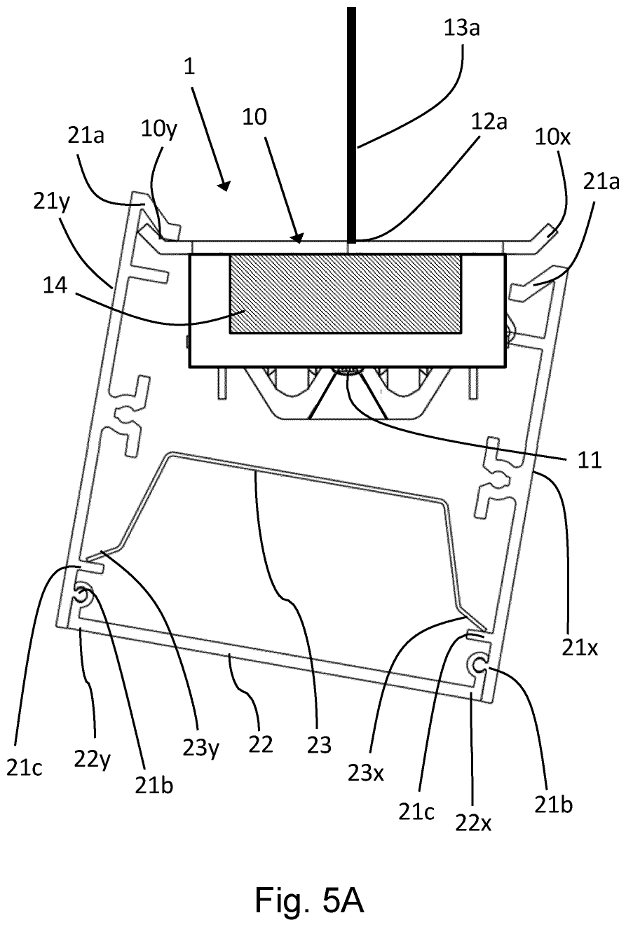

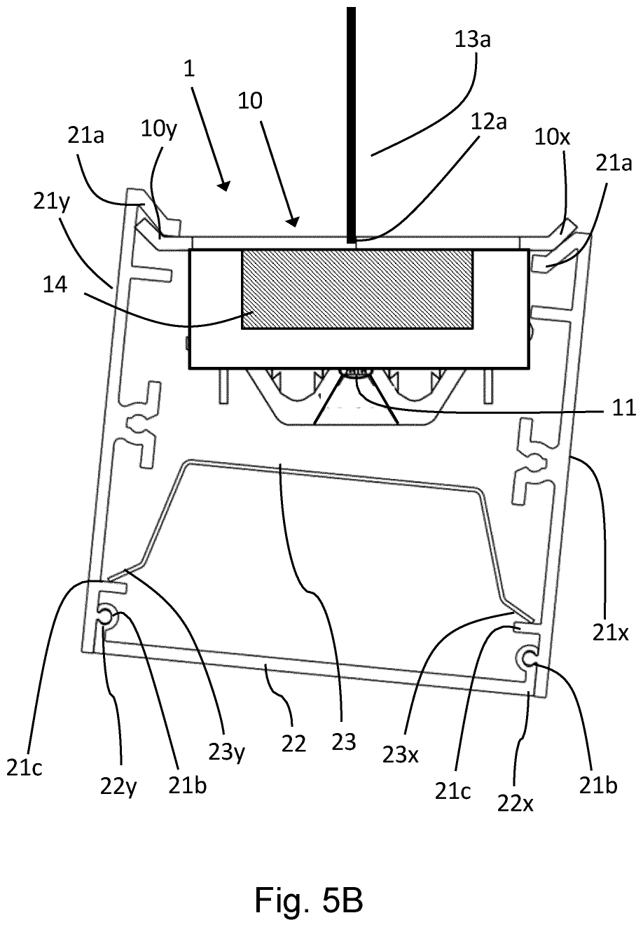

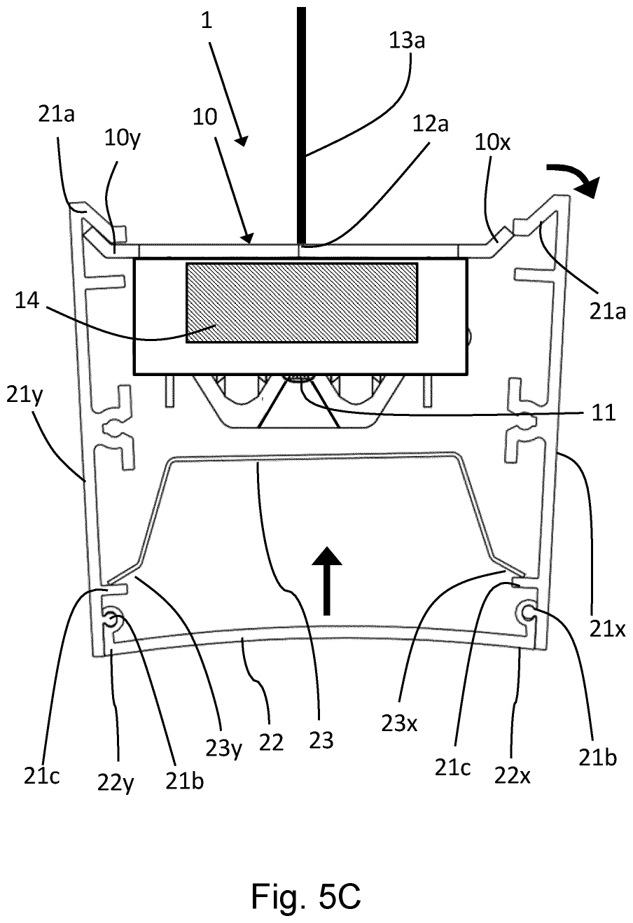

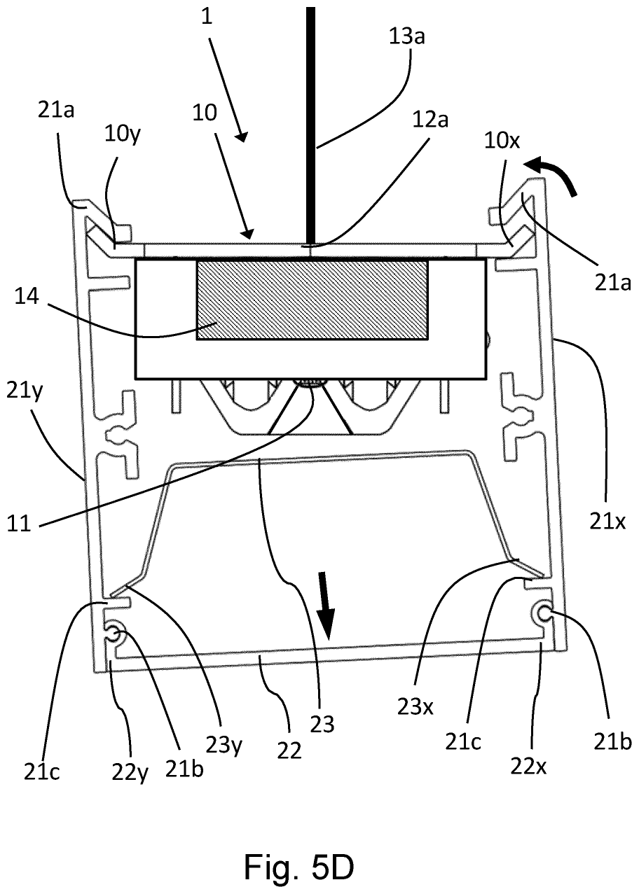

This modular assembly forms a flexible fixture housing 20 (see FIG. 3A) and its flexibility allows for an easy mounting to the elongated strip shaped fixture base plate 10 as shown in FIGS. 5A-5D. Both the elongated strip shaped fixture wall plates 21x and 21y and the light exit window 22 are made from a flexible synthetic material (like plastics), which allows for a certain degree of bending (see the bold arrows in FIG. 5D) of the parts for assembling and disassembling purposes. The certain degree of bending of the parts prevent damage.

The present disclosure also relates to an illumination system 100 for line illumination as shown for example in FIGS. 4A and 4B. Such illumination system 100 for line illumination can be composed of two or more elongated trunk fixtures 1 as described above. In FIG. 4A an illumination system 100 for line illumination is suspended from a ceiling (not disclosed) by means of suspension cables 13a-13b-13b. The illumination system 100 comprises a first trunk fixture 1 and a further trunk fixture 1′, which are interconnected with each other along their longitudinal dimension.

It is noted, that the illumination system 100 can be composed of one or more trunk fixtures 1, for example three, four or more than five.

For interconnecting the trunk fixtures 1-1′-etc. with each other in their longitudinal orientation, a coupling member 30 can be used. In an example, the coupling member 30 has a plate shaped configuration and it provided with a first coupling portion 30a and a second coupling portion 30b.

Two adjacent trunk fixtures 1 and 1′ are positioned in alignment along their longitudinal orientation such that the second base plate end 10b of the first trunk fixture 1 abuts against the first base plate end 10a′ of the further trunk fixture 1′. In order to keep the gap x between the two abutting (adjacent) elongated fixture base plates 10 and 10′ minimal, the coupling member 30 is placed over the gap x, such that each coupling portion 30a and 30b overlaps a corresponding base plate end 10b and 10a′ of fixture base plates 10 and 10′, respectively.

31 With the use of mounting screws 31, which pass through mounting openings 30z present in each coupling portion 30a and 30b and mount in suitable openings (not shown) present in elongated fixture base plate 10 and 10′ near the corresponding base plate end 10b and 10a′, the coupling member 30 can be fixedly secured with each abutting elongated fixture base plate 10 and 10′.

The mounting openings 30z present in each coupling portion 30a and 30b overlap with each opening present in the elongated fixture base plate 10 and 10′. This ensures that the elongated fixture base plate 10 and 10′ are properly fixed against each other maintaining the gap x minimal and guaranteeing a proper coherence of the multiple trunk fixtures 1-1′-1 etc. forming the trunking illumination system 100.

It should be noted that the modular design of the trunk fixture 1 according to the disclosure can be manufactured and shipped as a kit of loose parts, with the kit at least comprising an elongated strip shaped fixture base plate 10, at least two elongated fixture wall plates 21x-21y and an elongated light exit window plate 22 as described in this application. Additionally, the kit of loose parts may further comprise an elongated reflector plate 23 as disclosed, and the elongated strip shaped fixture base plate 10 of the kit may be provided with at least one light emitting element 11 and with suitable power electronics 14 for supplying power to the at least one light emitting element 11.

### LISTING OF REFERENCE NUMERALS USED

100 trunking illumination system for line illumination
1-1′ illumination trunk fixture/further illumination trunk fixture
10-10′ fixture base plate/further fixture base plate
10x left longitudinal base plate side edge of (further) fixture base plate
10y right longitudinal base plate side edge of (further) fixture base plate
10a(′)-10b(′) first/second base plate end of (further) fixture base plate
11 light emitting source/element
14 power electronics
15 bend base plate ridge
12a-12b suspension opening in (further) fixture base plate
13a-13b-13b′ suspension cable with power wiring incorporated
20 fixture housing
21x-21y left/right elongated fixture wall plate
21a first elongated fixture wall plate edge
21b second elongated fixture wall plate edge
21c elongated fixture wall plate flange
21d first longitudinal side of wall plate
21e second longitudinal side of wall plate
22 elongated strip shaped light exit plate (light exit window)
22x-22y left/right light exit plate edge
23 inner reflector plate
23x-23y left/right reflector plate edge
24 light exit opening
25 thickened part of wall plate
26 reflector opening
30 coupling member
30a first coupling portion
30b second coupling portion
30z mounting openings of coupling member
31 mounting screw
40a-40b fixating screw
X gap between adjacent elongated fixture base plates

1. An elongated trunk fixture for a trunking illumination system for line illumination, the elongated trunk fixture at least comprising a fixture housing comprising a light exit opening and a light exit window connected to the fixture housing and covering the light exit opening, the fixture housing being composed of an elongated strip shaped fixture base plate and elongated fixture wall plates, the base plate being provided with at least one light emitting element, the elongated fixture wall plates being releasably connected with the elongated strip shaped fixture base plate, wherein both the elongated strip shaped fixture wall plates and the light exit window are made from a flexible synthetic material.

2. The elongated trunk fixture according to claim 1, wherein the elongated fixture wall plate is provided with a first wall plate edge near a first longitudinal side of the elongated fixture wall plate, the first wall plate edge interacting with a longitudinal edge of the elongated strip shaped fixture base plate.

3. The elongated trunk fixture according to claim 2, wherein the first wall plate edge of the elongated fixture wall plate or the longitudinal edge of the elongated strip shaped fixture base plate are provided with an elongated thickened part, which elongated thickened part releasably fits in an elongated slot provided on the longitudinal edge of the elongated strip shaped fixture base plate or the first wall plate edge of the elongated fixture wall plate.

4. The elongated trunk fixture according to claim 1, wherein the elongated fixture wall plates are releasably connected with the light exit window.

5. The elongated trunk fixture according to claim 4, wherein the elongated fixture wall plate is provided with a second wall plate edge near a second longitudinal side of the elongated fixture wall plate, the second wall plate edge releasably interacting with a longitudinal edge of the light exit window.

6. The elongated trunk fixture according to claim 5, wherein the second wall plate edge of the elongated fixture wall plate or the longitudinal edge of the light exit window are provided with an elongated thickened part, which elongated thickened part releasably fits in an elongated slot provided on the longitudinal edge of the light exit window or the second wall plate edge of the elongated fixture wall plate.

7. The elongated trunk fixture according to claim 1, wherein the light exit window is configured as an elongated strip shaped light exit plate.

8. The elongated trunk fixture according to claim 1, further comprising an elongated reflector plate.

9. The elongated trunk fixture according to claim 8, wherein the elongated fixture wall plate is provided with an upright elongated fixture wall plate flange interacting with a longitudinal reflector plate edge of the elongated reflector plate.

10. The elongated trunk fixture according to claim 1, wherein the wall plates are diffusely translucent for visible light.

11. The elongated trunk fixture according to claim 1, wherein the elongated strip shaped fixture base plate is provided with power electronics for supplying power to the at least one light emitting element.

12. The elongated trunk fixture according to claim 11, wherein the elongated strip shaped fixture base plate is provided with suspension openings for attachment with suspension power supply wiring.

13. An illumination system for line illumination composed of two or more elongated trunk fixtures according to claim 1.

14. A kit of parts comprising:
an elongated strip shaped fixture base plate;
at least two elongated fixture wall plates; and
an elongated light exit window plate.

15. The kit of parts according to claim 14, the kit further comprising an elongated reflector plate.
